(19) United States
(12) Patent Application Publication
(10) Pub. No.: US 2004/0096543 A1
(43) Pub. Date: May 20, 2004

(54) Fish food made from invertebrate organisms

(76) Inventor: Jean-Marie Puff, Montpellier (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/472,339

(22) PCT Filed: Mar. 21, 2002
(86) PCT No.: PCT/FR02/00990

(30) Foreign Application Priority Data
Mar. 22, 2001 (FR) 0103882

(51) Int. Cl. A01K 1/00

(52) U.S. Cl. 426/2

(57) ABSTRACT

The invention relates to fish food comprising whole invertebrate organisms coated with a hydrocolloid suspension in aqueous phase. Said hydrocolloid can be gelated. The inventive fish food can be used for aquaculture, fish farming, aquariology or as fish bait.

### BACKGROUND OF THE INVENTION

This invention relates to a new food for fishes. Its domains of use are aquaculture, aquarium feeding and fishing. Food or baits for fishes now on the market may be classified into six main categories: living preys, fresh food, frozen food, freeze-dried food, dry baits, dry food as flakes, spangles or granulates. Due to to tile difficulty to store living preys, most of tile products on the market are dry and freeze-dried foods which have not tile appearance of preys and are not consequently very attractive to fishes.

The invention relates to a food material based on whole invertebrate organisms. Some of these organisms can be maintained in a living state and are then called hereinafter living preys or living baits.

The whole preys and particularly the whole living preys are of interest for fish breeders, aquariarists and fishers. A number of animal specie are thus on tie market: invertebrates like small shellfishes, worms; vertebrates like small fishes, for example; aquatic larvae of insects such as Chironiinus sp also called blood worm larvae earth larvae of insects like maggots for example.

The processing extending since harvesting tip to using this food for fish comprises packaging, transportation, storing and conditioning. These products are sometimes imported from remote countries : Ukraine for Clironiniius larvae, Korea and USA for worms, etc., but one must face problems even for transportation between two close countries. Transportation and storing must be made under controlled temperature conditions: living preys, depending on their type, survive in selected media (algae, gravels, water, peat, etc, for worms; paper, cloth, sawdust for larvae; water for shellfishes, for example) and in specific packages: paperboard, polystyrene, plastic films, paper, by example.

All these operations are expensive; the survival of the animals is not certain and the supply may be short for the clients. Certain zones in the world which have sufficient resources cannot contribute to satisfy the demand since failing of appropriate logistics.

Living food or baits are offered to the consumers in different containers, either in water or in a dry state, and their survival time at the retailer is usually about one week.

There is thus a recognized need of fish food in. the form of whole organisms, preferably living ones, whose storage life could be increased and which could appear in a shape easily accepted by fishes.

### SUMMARY OF THE INVENTION

This invention satisfies this need by supplying food for fishes (food is intended to include baits) based on whole invertebrate organisms, preferably in a living state. This food consists of whole invertebrate organisms, particularly insect larvae, coated with a hydrocolloid dispersion in liquid phase. The hydrocolloid is preferably used as a gel.

### DETAILED DESCRIPTION OF THE INVENTION

Hereinafter, it is intended as a matter of understanding that hydrocolloid means a hydrocolloid dispersion in a liquid phase, preferably an aqueous phase.

In a first embodiment, the food consists of a mixture of one or more whole invertebrate organisms with a hydrocolloid dispersion.

In a preferred embodiment, the food is a product obtained by admixing one or more whole invertebrate organisms with a hydrocolloid dispersion, followed with gelling of the mixture. There are thus obtained one or more whole invertebrate organisms coated with a gelled hydrocolloid.

A number of initially living invertebrate organisms die during the above treatments or thereafter, but it has been. found that their storage life was substantially increased in comparison with the same organisms which had not been so treated.

A preferred embodiment consists of using living larvae of insects or shellfishes such as Artemia. A great number of them remain in life for a long time following these treatments, which makes them particularly attractive for aquariarists and as baits for fishes.

These larvae may belong to insects of earth or water origin, the latter being preferred since their storage life is longer. Non-limitative examples of species are: Chironimus sp, Corethra plumicornis sp, Chaoborus sp and Tubifex sp.

The skilled people can easily determine by simple prior experiments which initially living invertebrates can be coated with a hydrocolloid gel without damage.

The invertebrates which are concerned by the invention are generally of small size, for example of a unit weight less than 100 grams and mostly less than 1 gram.

The useful hydrocollids are numerous, either of natural origin or synthetically produced. They can be dispersed in water or in an aqueous phase. Examples of hydrocolloids of natural origin are : alginates, carrageenans, xanthane, gums, proteins, casein, gelatin or mixtures thereof Examples of synthetic hydrocolloids are carboxymethylcellulose, marigel, anionic polyacrylamides or mixtures thereof. These examples being not a limitation of the invention.

Mixtures of natural and synthetic hydrocolloids can also be used.

In view of the expected use, hydrocolloids of natural and aquatic origin which are dispersible at room temperature are preferred at similar performances.

The preferred process of manufacture of a food according to the invention comprises admixing one or more whole invertebrate organisms, preferably one or more living larvae, with an aqueous dispersion (sol) of a hydrocolloid, followed by gelling the resulting mixture. Gelling, also called coagulation, is obtained by any convenient means not detrimental to the organism, for example a larva. If it is desired to maintain the organism in life, the temperature will thus be selected to be compatible with the life of the organism. A number of organisms resist to temperatures up to 50° C. or more, whereas others must be maintained below, for example, 30° C.

Gelling results in forming a coating which encloses the larvae or other whole organisms by forming a cocoon around them.

Gelling can be obtained in a number of ways, for example by thermal coagulation of certain hydrocolloids, for example egg albumin, or by reacting with an acid or compounds providing alkaline-earth ions in aqueous solution, for example salts of alkaline-earth metals, such as a solution of calcium chloride (preferred), calcium acetate or calcium formate; it is thought that ions of opposed signs will form bridgings and consequently a gelly. Other means for gelling hydrocolloids known to the skilled people could also be used,

The latter operation can be made at room temperature with certain hydrocolloids, thus without heating, which is necessary with living organisms whose lethal temperature is often about 30° C. The food portion is thus coated with an envelope or, in other words, a skin, a shell or a. cocoon. The latter will protect the food against dehydration, oxydation and frosting.

The formation of this envelope is easy with such hydrocolloids as sodium alginate extracted from brown algae such as seaweed, laminars etc., carrageenan extracted from red algae such as Chondrus Crispus, and which are of common use as ingredients in food products.

The preferred process for manufacturing a food according to the invention comprises three essential steps: dispersing a hydrocolloid in an aqueous phase (forming a sol ), thoroughly admixing the (preferably living) organism(s) with said aqueous phase and contacting the resultant mixture with a gelling agent. Doses of the mixture of the hydrocolloid dispersion with the invertebrate organism can be fed, for example by extrusion, into an aqueous bath of alkaline-earth metal salt, the doses forming a gel upon immersion into the bath. The aqueous solution of alkaline-earth ions can also be sprayed onto individual doses of the above mixture placed in molds.

An important feature of the present process and of the food and baits according to the invention is to proceed with whole invertebrate organisms (or at least with fragments of these invertebrates sufficiently important to have the fishes identifying them as the invertebrates themselves), preferably whole living invertebrate organisms. The latter will thus be coated with the hydrocolloid dispersion and the cocoon optionally formed by at least partial gelling on said organisms. This process thus differs from the known process in which powdered food is admixed with a hydrocolloid and the global mixture obtained is gelled thereafter. The natural appearance of the organism is thus preserved and this is very attractive both to the fish and to the retailer and his clients.

The skilled artisan. will easily select the fundamental features of the process. Those are notably the nature of the hydrocolloid or mixtures thereof, the nature of the gel-former (gelling agent) or gel-former in admixture, the hydrocolloid concentration which depends on the free water content in the food, the food/gel ratio, the nature of water (its salt composition, that of die alkaline-earth metal ions), the possible addition of nutritive ingredients such as sugar, starch, pyrophosphates, algae, specially living mono cellular algae, the reaction temperature, the gel age, the ions content in the ionic solution, the time of contact of the hydrocolloid/food mixture with the ionic solution, the optional washing of the product obtained, its optional drying, its packaging and notably tile nature of the packaging and its permeability to gas. Simple previous experiments will show to tile skilled people how to determine the optimal conditions in each particular case of application.

It must be understood that only ingredients which are not toxic to fish can be used to manufacture food according to the invention.

The results can be ascertained according to a number of criteria such as: optimal storing time, time limit for storage, organoleptic qualities, storing times depending on temperature, absence of syneresis, method of manufacture, for example extruding or molding, or influence of other features, possibility to obtain small doses and regularity thereof, case of use by the consumer and fish, optional floating of the dose, living time of the cocoon and sanitary quality.

The resultant cocoons can be dried. They have after drying a net dry weight close to the gross weight of the cocoon, which contributes to reduce the costs of transportation and storage,

The cocoon cannot be easily destroyed: only high temperatures or immersion in an aggressive bath such as a bath with sodium ions in high concentration call destroy it, which conditions are normally not encountered during its storing or use. However destroyed cocoons can be found, due to lysis caused by microorganisms such as bacteria; thus to avoid this destruction, only secure materials should be used. The living organisms will thus be preferably purified in pond and sorted.

A cocoon in good state is a proof of a good sanitary state of the product.

The process can be used to produce fishing baits obtained by agglomerating in a same cocoon several appetency preys when the latter are too small for the type of fish whose capture is desired. The cocoon will have the size and shape desired for this type of fishing. Some fishes will absorb the invertebrate organism with the cocoon. whereas other will break the cocoon to absorb only the organism contained in the cocoon.

The process can also be used to manufacture a product attractive to fishes which can float, settle in the bottom or be maintained by a float in full water.

The doses obtained by this process can be frozen. The resulting product has organoleptic qualities better than those obtained by the processes presently known. The cocoon preserves the product upon defrosting and avoids syneresis. The doses can be adapted to the demand and the product has a lower cost than when obtained by the processes in actual use and the cost of the packaging material remains low. The product is well adapted to freezing in a brine bath, which is less expensive than freezing in a freezing cell or tunnel. In comparison with packaging with a blister, for example, the packaging of the coated food according to the invention does not require non-recyclable materials which, on burning, evolve toxic gases. The use is easy and the sanitary quality is good.

Not all the invertebrates used to feed fishes can be maintained in life when stored in a cocoon; the process is particularly well adapted to larvae of insects which, as a rule, can remain in life over a rather long period. The other available living products used as food for fishes can usefully be prepared according to the same process and then frozen. The result is better than that obtained according to the now available processes of packaging and freezing and exhibits the above advantages.

The following examples are given for illustration of the invention and not for limitation. The impregnation rate is the ratio by weight of the invertebrate organism to the hydrocolloid dispersion.

### EXAMPLES

### Example 1

Living Chironomides (Chironomus sp) are admixed at 20° C. with a 1% b.w. dispersion of sodium alginate in tap water. The impregnation rate is 100%, which means that the Chironomides weight is the same as the weight of the dispersion. The resultant product is gelled thereafter by extrusion into a 40 g/liter solution of calcium chloride.

The gel-coated Chironomides thus obtained can be stored at about 2° C. in a sealed polyethylene bag of 30 micron thickness and are found in life and in good condition after 30days. After 36 days they have again a good appearance and are found living although they have lost some weight.

They have then been frozen and have retained an excellent appearance after a 6 month storage.

### Example 2

Chironomides are admixed with a 0.6% b.w. dispersion of sodium alginate in distilled water. The impregnation rate is 25%. This material is distributed into molds and an aqueous 40 g/liter solution of calcium chloride is sprayed onto the molds. The products are packed in a 75 micron sealed polyethylene film. After 30 days of storage at about 0-5° C., the Chironomides are living and have an excellent appearance. They have then been frozen and they retained an excellent appearance after 6 months.

### Example 3

Chironomides are admixed with a 1% b.w. dispersion of sodium alginate in tap water at an impregnation rate of 50% and are thereafter extruded into a 60 g/liter calcium chloride solution in water. The resultant cocoons are stored in a dry state for 24 hours and then stored at 2° C. in a 30 micron sealed polystyrene film. After 65 days the Chironomides are found living and can be frozen and stored for more than 6 months while retaining an excellent appearance.

### Example 4

Example 1 is repeated except that maggots of 1 week age are substituted for Chironomides. The resultant product is stored at 5° C. in a sealed polystyrene film. After 20 days, the maggots are found living aid start their metamorphosis.

### Example 5

Example 1 is repeated with white mosquito larvae (Corethra plumicornis). The storage life has been 28 days.

### Example 6

Cocoons identical to those obtained in the above Examples 1 to 3 were found in good state after 5 days at 20°l C. and 8 days at 12° C.

### Example 7

Example 1 is repeated except that the hydrocolloid is carrageenan. The survival time was 40 days. The cocoon was however not so strong as that of example 1.

### Example 8

Example 1 is repeated, however with waters containing cultures of Chlorella sp and Dunalliela sp algae respectively. The survival of the Chironomides was excellent up to 30 days. They have then been frozen and have retained a satisfactory appearance.

### Example 9

Example 1 is repeated except that the calcium chloride solution is saturated at 20° C. The survival time was 30 days.

What is claimed as my invention:

1. Food for fishes based on invertebrate organisms, wherein the food comprises whole invertebrate organisms coated with a hydrocolloid suspension in liquid phase.

2. Food for fishes based on invertebrate organisms, wherein the food comprises whole invertebrate organisms coated with a gelled hydrocolloid in liquid phase.

3. Food according to claim 1 or claim 2, wherein the invertebrate organisms are living insect larvae or living shellfishes.

4. Food according to anyone of claims 1 to 3, wherein the invertebrate organisms are larvae of Chironomus sp, Chaoborus sp or Tubifex sp.

5. Food according to anyone of claims 1 to 4, wherein microscopic monocellular algae are also present in admixture with the hydrocolloid.

6. Process for manufacturing food for fishes , wherein one or more whole invertebrate organisms are admixed with a hydrocolloid suspension in liquid phase.

7. Process according to claim 6, wherein the resultant mixture is then subjected to gelling of the hydrocolloid suspension liquid phase.

8. Process according to anyone of claims 6 or 7, wherein the invertebrate organisms are living insect larvae or living shellfishes.

9. Process according to anyone of claims 6 to 8, wherein the invertebrate organisms are larvae of Chironimus sp, Corethra plumicornis sp, Chaoborus sp or Tubifex sp.

10. Process according to anyone of claims 6 to 9, wherein the hydrocolloid is selected from alginates, carageenans, xanthane, gums, proteins, casein and gelatin.

11. Process according to anyone of claims 6 to 10, wherein gelling is carried out by contacting the mixture of whole invertebrate organisms and hydrocolloid dispersion with an acid or a compound generating alkaline-earth ions in solution.

12. Process according to claim 11, wherein gelling is obtained by contacting with a calcium chloride solution.

13. Process according to anyone of claims 6 to 12, wherein the mixture of one or more whole invertebrate organisms and hydrocolloid dispersion is arranged in molds and sprayed with an aqueous solution of acid or of a compound generating alkaline-earth ions or extruded by doses in an aqueous bath of said dispersion.

14 Process according to anyone of claims 6 to 13, wherein the aqueous hydrocolloid dispersion is a suspension of said hydrocolloid in a culture of microscopic mono cellular algae,

15. The use of a food according to anyone of claims 1 to 5, or prepared according to anyone of claims 6 to 14 to feed fishes, particularly for aquaculture, fish feeding or aquarium feeding, or as a bait for fishing.
